(19) United States
(12) Patent Application Publication
(10) Pub. No.: US 2010/0201836 A1
(43) Pub. Date: Aug. 12, 2010

(54) MOBILE DEVICE AND METHOD FOR EXECUTING VISUAL PRESENTER FUNCTION AND HOLDER FOR THE MOBILE DEVICE

(75) Inventors: Young Hwa KIM, Seoul (KR); Soo Hyung KIM, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/701,860

(22) Filed: Feb. 8, 2010

(30) Foreign Application Priority Data
Feb. 10, 2009 (KR) 10-2009-0010405

(51) Int. Cl. H04N 5/228; G03B 21/00; F16M 11/18; F16M 11/04

(52) U.S. Cl. 348/222.1; 353/121; 248/419; 248/122.1; 348/E05.031

(57) ABSTRACT

A mobile device having a projector module and a camera provides a visual presenter function. A method for executing such a visual presenter function in the mobile device includes selecting a visual presenter mode in a menu of the mobile device, and activating the camera of the mobile device when the visual presenter mode is selected. The method further includes acquiring an image of a target object through the camera, activating the projector module of the mobile device, and projecting the acquired image onto an external display screen through the activated projector module. A holder may be used to securely support the mobile device and selectively adjust the position of the mobile device.

### CLAIM OF PRIORITY

This application claims the benefit of the earlier filing date, pursuant to 35 USC 119, of that patent application entitled “MOBILE DEVICE AND METHOD FOR EXECUTING VISUAL PRESENTER FUNCTION AND HOLDER FOR THE MOBILE DEVICE” filed in the Korean Intellectual Property Office on Feb. 10, 2009 and assigned Serial No. 10-2009-0010405, the contents of which are incorporated herein by reference.

### BACKGROUND OF THE INVENTION

1. Field of the Invention

The present invention relates to a mobile device having a projector module and a camera and a method of executing a visual presentation using the mobile device, and a holder for the mobile device.

2. Description of the Related Art

A rapid advance in mobile communication technologies is converting traditional mobile devices with many useful applications that meet customers' demands. Accordingly, mobile users today are capable of manipulating various forms of voice, text, graphic, etc. as well as music, multimedia, game, etc.

However, mobile devices have inherent limitations in size, especially with their display unit. This may restrict the presentation of output data on the small and limited display unit. Therefore, these days a projector module is sometimes employed which magnifies output data, such as a still image or a moving image. A user of a mobile device with a projector module can project output data on a sufficiently large sized external display screen,

However, such a mobile device equipped with a projector module was only recently developed. Hence, these mobile devices are short of functions available for user's convenience in connection with a projector module. Accordingly, a lot of improvement in function of a mobile device having a projector module is needed.

### BRIEF SUMMARY OF THE INVENTION

Accordingly, an aspect of the present invention is to address the above-mentioned problems and provides additional advantages, by providing a holder for a mobile device having a projector module and a camera, wherein an image is acquired by the camera and projected onto an external display screen through the projector module.

According to one aspect of the present invention, a method of executing a visual presenter function in a mobile device includes: selecting a visual presenter mode in a menu of the mobile device; activating a camera of the mobile device when the visual presenter mode is selected; acquiring an image of a target object through the camera; activating a projector module of the mobile device; and projecting the acquired image through the activated projector module.

According to another aspect of the present invention, a mobile device for executing a visual presenter function includes: a camera configured to be activated when a visual presenter mode is selected and to acquire an image of a target object; a projector module configured to project the acquired image; and a control unit configured to control the projector module to project the acquired image.

According to yet another aspect of the present invention, a holder for a mobile device includes: a device fixing part which securely fixes the mobile device, which includes a camera configured to be activated when a visual presenter mode is selected and to acquire an image of a target object, a projector module configured to project the acquired image, and a control unit configured to control the projector module to project the acquired image; a horizontal member which movably supports the device fixing part and allows a horizontal movement of the device fixing part; and a vertical member which movably supports the horizontal member and allows a vertical movement of the horizontal member.

According to aspects of the present invention, it is possible to execute a visual presenter function through only the mobile device by projecting an image acquired by the camera onto an external display screen through the projector module. Additionally, aspects of the present invention may enhance the convenience of image acquisition and projection by employing the holder to securely support the mobile device and adjust the position of the mobile device.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a perspective view illustrating a visual presenter apparatus using a mobile device in accordance with an exemplary embodiment of the present invention.

FIG. 2 is a block diagram illustrating a configuration of a mobile device in accordance with an exemplary embodiment of the present invention.

FIG. 3 is an elevation view illustrating a spatial relation between a mobile device and a target object in accordance with an exemplary embodiment of the present invention.

FIG. 4 is a flow diagram illustrating a method for executing a visual presenter function in accordance with an exemplary embodiment of the present invention.

FIG. 5 is a flow diagram illustrating a method for executing a visual presenter function in accordance with another exemplary embodiment of the present invention.

### DETAILED DESCRIPTION OF THE INVENTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

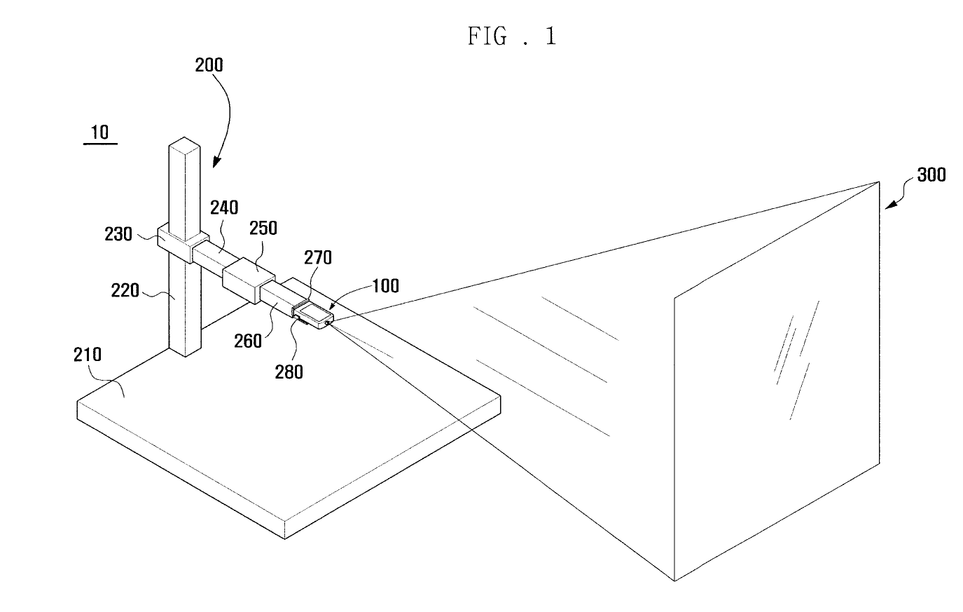

FIG. 1 is a perspective view of a visual presenter apparatus using a mobile device in accordance with an exemplary embodiment of the present invention.

As shown, a visual presenter apparatus 10 according to the present invention includes a mobile device 100, a holder 200 for holding the mobile device 100, and an external display screen 300 onto which an image is projected from the mobile device 100.

Briefly, in the visual presenter apparatus 10, the mobile device 100 is detachably coupled to a device fixing part 280 of the holder 200, and a target object (not shown) is placed on a base board 210 of the holder 200. The mobile device 100 acquires an image of the target object through a camera (not shown) thereof and projects the acquired image onto the external display screen 300 through a projector module (not shown) thereof. As a result, an image of the target object is presented on the external display screen 300.

The external display screen 300 provides a surface on which an image projected from the projector module of the mobile device 100 is formed. A projection screen separately fabricated may be used as the external display screen 300. However, a wall, a blind such as a window shade, a blackboard, a whiteboard, or any other types of flat surfaces capable of images being projected thereon may be used as the external display screen 300. The image formed on the external display screen 300 may vary in size according to a distance from the projector module of the mobile device 100.

The holder 200 is configured to securely support the mobile device 100 and adjust the position of the mobile device 100. The holder 200 may include the base board 210 on which the target object is placed, the device fixing part 280 which securely fixes the mobile device 100, a horizontal member which movably supports the device fixing part 280, and a vertical member which movably supports the horizontal member. Here, the horizontal member may include a first horizontal arm 240, a horizontal movable joint 250, a second horizontal arm 260, and a rotational joint 270. The vertical member may include a post 220 and a vertical movable joint 230.

The base board 210 has a flat surface on which the target object is placed. In alternate embodiment, the base board 210 may be omitted. In order to enhance images being captured, the base board 210 may be configured to irradiate light. The size of the base board 210 may be substantially larger than, for example, the A4 paper size. Considering portability, the base board 210 may have a foldable structure or an assembled structure. Further, one portion of the base board 210 may be connected with the post 220.

The post 220 is extended upwardly from one end of the base board 210, for example, from a center of one side of the base board 210. Considering portability, the post 220 may have a bendable structure or an assembled structure in association with the base board 210. The post 220 may have various shapes such as a square pillar, a triangular prism, a cylinder, etc. and may be formed in a group. Further, the post 220 may have scales thereon which allow a user to intuitively know a height.

The vertical movable joint 230 is movably fixed to the post 220 and securely supports the first horizontal arm 240. The vertical movable joint 230 can move up and down along the post 220. For this, the vertical movable joint 230 may have a vertically penetrating hole into which the post 220 is inserted. Furthermore, the vertical movable joint 230 may have a screw-type tightener by which the vertical movable joint 230 can be firmly fixed to the post 220 after upward and downward movements.

The first horizontal arm 240 is interposed between the vertical movable joint 230 and the horizontal movable joint 250, while movably supporting the horizontal movable joint 250 in a horizontal direction. When the vertical movable joint 230 moves up and down, the first horizontal arm 240 moves accordingly together with the horizontal movable joint 250.

The horizontal movable joint 250 is interposed between the first horizontal arm 240 and the second horizontal arm 260. The horizontal movable joint 250 movably supports the second horizontal arm 260 in a horizontal direction, thus allowing a horizontal movement of the second horizontal arm 260. Therefore, the horizontal movable joint 250 allows adjusting the entire horizontal length from the first horizontal arm 240 to the second horizontal arm 260.

The second horizontal arm 260 is interposed between the horizontal movable joint 250 and the rotational joint 270. The second horizontal arm 260 is movably inserted into the horizontal movable joint 250 at one portion thereof. It is therefore possible to adjust the horizontal position of the device fixing part 280 by regulating the extent of the inserted portion of the second horizontal arm 260 through back and forth movements. Similar to the post 220, the second horizontal arm 260 may have scales thereon which allow a user to precisely regulate a horizontal length.

The rotational joint 270 is disposed at the end of the second horizontal arm 260 and is also connected with the device fixing part 280. The rotational joint 270 allows the device fixing part 280 to rotate freely in a stationary position. Thus, it is possible for the mobile device 100 being fixed to the device fixing part 280 to change a projecting direction of an image projected onto the external display screen 300 through the projector module.

The device fixing part 280 is configured to securely fix the mobile device 100, while being spaced apart from the base board 210. The device fixing part 280 may have a receptacle in which the mobile device 100 is located, and a fixer by which the mobile device 100 is detachably coupled thereto. Further, the device fixing part 280 may have, but not limited to, an aperture such as a slit through which the camera of the mobile device 100 takes a picture toward the base board 210.

As discussed heretofore, the holder 200 is provided to securely fasten the mobile device 100 and allows the camera of the mobile device 100 to precisely take a photograph of the target object on the base board 210. In an alternate embodiment, the holder 200 may be omitted.

Note that the holder 200 of the present invention may be not limited to the above discussed configuration. The base board 210 is optional and may be omitted accordingly. Additionally, the horizontal member may be composed of several arms and several joints, or any combination thereof. Therefore, the holder 200 of this invention may be variously altered in configuration and shape but maintain its essential functions to securely support the mobile device 100 and to adjust the position and angle of the camera of the mobile device 100.

The mobile device 100 is fixed to the device fixing part 280 of the holder 200. The mobile device 100 acquires an image of the target object on the base board 210 through the camera thereof and projects the acquired image onto the external display screen 300 through the projector module thereof. The mages to be projected can also be previously stored images. Now, a configuration of the mobile device 100 will be described hereinafter.

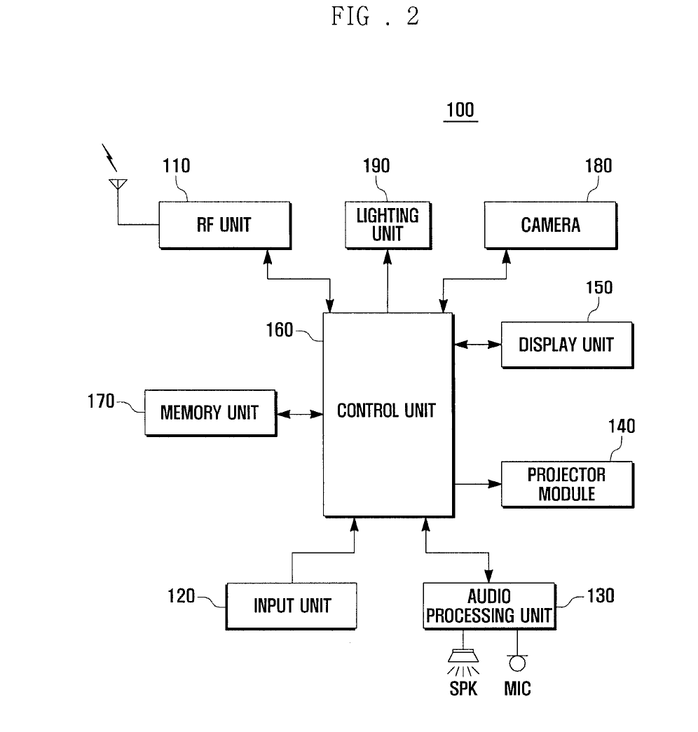

FIG. 2 is a block diagram of a mobile device in accordance with an exemplary embodiment of the present invention.

Referring to FIG. 2, the mobile device 100 includes a radio frequency (RF) unit 110, an input unit 120, an audio processing unit 130, a projector module 140, a display unit 150, a memory unit 170, a camera 180, a control unit 160, and a lighting unit 190.

In operation, the mobile device 100 having the above listed configuration processes an image acquired through the camera 180 and then projects the processed image through the projector module 140. Now, each individual element will be described in detail hereinafter.

The RF unit 110 establishes necessary communication channels under the control of the control unit 160. That is, the RF unit 110 forms a voice call channel, a data communication channel, and a video call channel with a mobile communication system. The RF unit 110 may include an RF transmitter that upwardly converts the frequency of signals to be transmitted and amplifies the signals, and an RF receiver that amplifies received signals with low-noise and downwardly converts the frequency of the received signals. The data transmission channel established by the RF unit 110 may be temporarily formed to perform a given message service with the mobile communication system and then released after a message is sent or a reception is completed.

Particularly, the RF unit 110 of this invention may perform a missed call function for a call received while the mobile device 100 operates in a visual presenter mode. A missed call may be not notified or displayed until a visual presenter mode is finished. Alternatively, a signal indicative of an incoming call may be provided.

The input unit 120 includes a plurality of input keys and function keys which are provided to receive a user's input. Here, the function keys may have navigation keys, side keys, shortcut keys, and any other special keys. The input unit 120 creates various key signals in association with user's selection or commands and delivers them to the control unit 160. Specifically, the input unit 120 may create an input signal for selecting a visual presenter mode, a half-shutter key input signal for adjusting the focus of the camera 180, an input signal for setting an auto focusing function of the camera 180, an input signal for finishing a visual presenter mode, etc. and then send them to the control unit 160.

The audio processing unit 130 has a speaker (SPK) for outputting audio signals and a microphone (MIC) for receiving audio signals. Particularly, when an audio file stored in the memory unit 170 is played, the audio processing unit 130 may output audio signals in the audio file through the speaker (SPK). Therefore, in a visual presenter mode, the audio processing unit 130 may support a background music function related to image projection.

The projector module 140 outputs a variety of data to the external display screen. Specifically, the projector module 140 may output content stored in the memory unit 170, data received through the execution of particular functions such as a digital broadcasting application, data received from various external electronic devices such as PC, TV, VCR, DVD or camcorder, and data generated during the execution of specific applications. Also, the projector module 140 may project graphical elements such as a mouse pointer onto the external display screen under the control of the control unit 160.

The projector module 140 typically includes an image input part, a lens, a focus driving motor, a projection angle driving motor, and a projection angle sensor. The image input part receives data from the control unit 160, and the lens projects the received data onto any type of object such as a display screen. The focus driving motor regulates the focus of the lens on the display screen. The projection angle driving motor regulates the projection angle of data to be projected, and the projection angle sensor detects a projection angle and sends it to the control unit 160.

Particularly, the projector module 140 of this invention may be automatically activated when a visual presenter mode is selected. Here, the activated projector module 140 may project a preview image, a still image and a moving image, all of which are acquired by the camera 180, onto the external display screen. The display orientation/direction and display ratio of a projected image on the external display screen may be different from those of a displayed image on the display unit 150, respectively. The projector module 140 may regulate the display ratio of a projected image according to a preset value or a user's input.

The display unit 150 represents a variety of information inputted by a user or offered to a user, such as various menus of the mobile device 100. That is, the display unit 150 may provide many display pages, visual images, or graphical elements in association with the use of the mobile device 100, including an idle page with a static or dynamic background image, a menu page with several depths, a message input page, a call execution image, and any others related to the execution of contents or applications. Particularly, the display unit 150 of this invention may offer a menu page for selecting a visual presenter mode and, depending on a device presetting environment or a user's input, may output images obtained by the camera 180 in a visual presenter mode. That is, the display unit 150 may output a preview image, a still image and a moving image all of which are acquired by the camera 180.

An image displayed on the display unit 150 may be offered to the projector module 140. Therefore, an image projected onto the external display screen may be the same image as displayed on the display unit 150. Also, a displayed image on the display unit 150 is generally an image of the target object placed on the holder 200. Here, the mobile device 100 may switch the display direction/orientation of an image on the display unit 150 in order for a user to see better an image of the target object when there is a user's input. However, in this case, the display direction of an image on the external display screen may not be switched.

The display unit 150 may be formed of a liquid crystal display (LCD), an organic light emitting device (OLED), or any other equivalents. Also, the display unit 150 may be fabricated in a touch-based form such as a touch screen which has an input function in addition to a display function. For example, the display unit 150 may have a display panel and touch sensors disposed on the display panel. If a touch screen is available, the mobile device 100 may provide various touch-based menu pages on the touch screen and may often offer a full screen image according to a user's setting environment or preference.

The memory unit 170 stores a variety of applications required for the operation of the mobile device 100. Additionally, the memory unit 170 stores specific applications used for the execution of contents, and a key map or a menu map used for the operation of the touch screen. Here, the key map may have various well known types such as a keyboard map, a 3*4 key map, a qwerty key map, or a special control key map suitable for the operation of a specific application in use. Also, the menu map may have several menu items offered by the mobile device and may be a special menu map suitable for the operation of a specific application in use. The memory unit 170 may consist of a program region and a data region.

The program region stores an operating system (OS) for booting the mobile device 100, and applications used for the execution of various files or functions. Such applications may have an application for supporting a voice call or a video call, a web browser for access to the Internet server, an MP3 application for playing music, an image viewing application, a video playing application, a document editing application, etc. Particularly, the program region may store a visual presenter mode application.

The visual presenter mode application may include instructions to activate the camera 180, and instructions to convert an image obtained by the camera 180 into a new form adapted to the projector module 140. Additionally, the visual presenter mode application may include instructions to support an auto focusing function by which the camera 180 automatically adjusts a focus on the target object located in the holder 200, and instructions to support the maintenance of a focus formed by a half-shutter key until there is other or subsequent input. Also, the visual presenter mode application may include instructions to adjust the size of an image projected through the projector module 140 depending on information about the display ratio of such an image. Furthermore, the visual presenter mode application may perform a function to indicate a proposed separation distance between the mobile device 100 and the target object. This feature will be described in details later.

The data region stores data created while the mobile device 100 is in operation. In particular, the data region may store a great variety of contents. Also, the data region may store user's input received through a touch screen when the display unit 150 is formed of the touch screen. Particularly, the data region may store still images and moving images obtained by the camera 180. A selected one of images stored in the data region may be projected onto the external display screen through the projector module 140 under the control of the control unit 160. Additionally, the data region may store audio contents processed in the audio processor unit 130 and, when the visual presenter mode application is activated, may forward the audio contents to the audio processor unit 130 under the control of the control unit 160.

The camera 180 is activated depending on an input signal from the input unit 120 and acquires images of the target object. An input signal for activating the camera 180 may be created when an item corresponding to a camera or a visual presenter mode is selected in menu options. Additionally, the camera 180 may provide an auto focusing function against the target object placed on the base board. The camera 180 may further provide a focus maintenance function. That is, after a user performs the adjustment of a focus on the target object by inputting a half-shutter key in a visual presenter mode, the camera 180 may control the adjusted focus to be maintained until there is other input.

The lighting unit 190 is disposed near the camera 180 and activated automatically or according to a user's input during a visual presenter mode. That is, the lighting unit 190 may provide a flashlight function that flashes a bright light suddenly or continually. Light emitted from the lighting unit 190 is spread over the base board, so that the camera 180 can obtain a clear and distinct image of the target object. In alternate embodiment, the lighting unit 190 may be turned on or off according to a user's setting. In another embodiment, if an illumination sensor is equipped, the lighting unit 190 may be automatically activated below a predetermined illumination value and inactivated above that value.

The control unit 160 supports an initialization procedure by controlling the power supply to each unit of the mobile device 100. After initialization, the control unit 160 may control signal flows between the respective units in order to support a visual presenter function when a visual presenter mode is selected.

Specifically, the control unit 160 may control the display unit 150 to output a menu page which contains a menu item allowing a user to select a visual presenter mode. Additionally or alternatively, if there is a hot key which allows directly starting a visual presenter mode, the control unit 160 may control the start of a visual presenter mode by depending on an input signal from the hot key. If a user selects a visual presenter mode through a menu displayed on the display unit 150 or by using the hot key, the control unit 160 may activate simultaneously or sequentially the camera 180 and the projector module 140.

That is, in a visual presenter mode, the control unit 160 may activate and control the camera 180 to acquire images. Here, the control unit 160 may control the display unit 150 to selectively output a real-time preview image taken by the camera 180.

Additionally, the control unit 160 may activate the projector module 140 and convert an image obtained by the camera 180 into a new form adapted to the projector module 140. Then, the control unit 160 may control the projector module 140 to project the converted image. Here, the control unit 160 may convert a preview image into a new form at a specific display ratio and a specific display direction/orientation, then forward the converted preview image to the projector module 140.

In a case where a preview image is not outputted on the display unit 150, the control unit 160 may output instead a menu page required for other optional functions in a visual presenter mode. For example, the control unit 160 may represent on the display unit 150 a menu item for adjusting the display ratio and display direction of a preview image projected onto the external display screen. If the display unit 150 is formed of a touch screen, a user can adjust the display ratio and display direction of a projected image from the projector module 140 by touching a desired item on the touch screen.

If the camera 180 acquires a still image, the control unit 160 may control the projector module 140 to project in a real time the acquired still image onto the external display screen. Here, such a still image may be stored in the memory unit 170 automatically or at a user's request. If the projector module 140 projects the stored still image, the control unit 160 may convert such a still image into a new form adapted to the projector module 140. At this time, the control unit 160 may halt functions of the camera 180.

Furthermore, if there is an input signal for taking a photograph, the control unit 160 may activate and control the camera 180 to acquire a still image of the target object on the base board. Then, the control unit 160 may store the acquired still image in the memory unit 170 and may control the projector module 140 to project the acquired still image onto the external display screen. Here, the control unit 160 may control the display unit 150 to output the still image. Alternatively, the control unit 160 may control the display unit 150 to output instead menu items for further optional functions, such as display ratio adjustment and display direction adjustment, in a visual presenter mode.

The control unit 160 may perform similar control functions for moving images as well as still images. That is, if there is an input signal for taking a video, the control unit 160 may activate and control the camera 180 to acquire a moving image of the target object on the base board. Then, the control unit 160 may perform an image processing of the acquired moving image and may control the projector module 140 to project the acquired moving image onto the external display screen. Also, if there is an input signal for halting a video-taking function, the control unit 160 may store the acquired moving image in the memory unit 170 automatically or at a user's request. Here, the control unit 160 may control the projector module 140 to repeatedly project the stored moving image onto the external display screen. Furthermore, the control unit 160 may inactivate the camera 180 and, if an input signal for taking a video is received again, may activate the camera 180. Besides, the control unit 160 may control the display unit 150 to output a moving image or to output instead menu items for further optional functions in a visual presenter mode.

As fully discussed hereinbefore, the mobile device according to an embodiment of the present invention is located in the holder and acquires a preview image, a still image or a moving image through the camera in a visual presenter mode. Then, the mobile device controls the projector module to project such images onto the external display screen. Therefore, the mobile device can perform a visual presenter function by using the camera and the projector module without requiring additional visual presentation equipments. Furthermore, the mobile device can offer an adjustment function of a display ratio and a display direction during an image projection. Although the above-discussed mobile device is located in the holder to acquire images of the target object, it is possible to remove the holder. In this case, the mobile device may be located in any place and the securely fixed to surrounding structures.

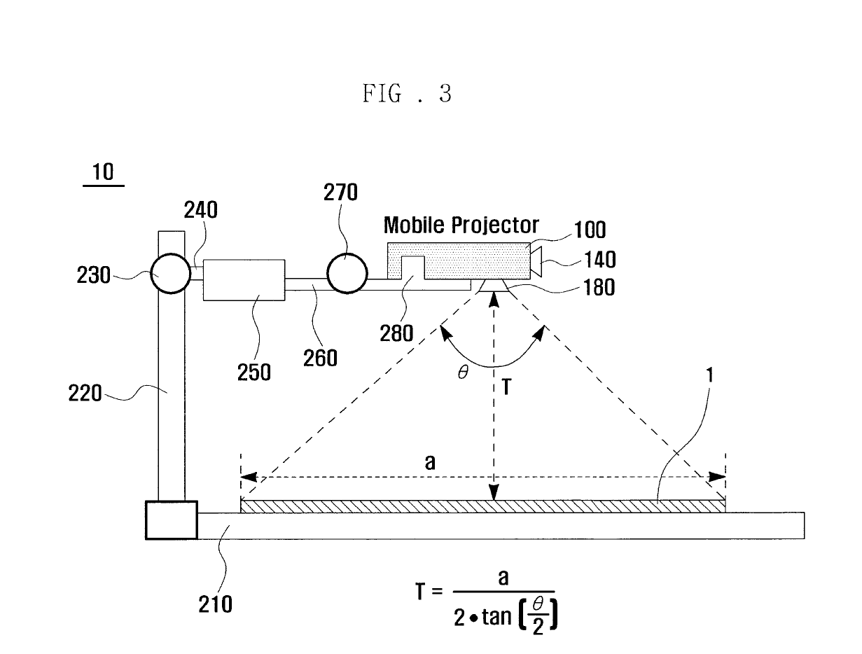

FIG. 3 is an elevation view which illustrates a spatial relation between a mobile device and a target object in accordance with an exemplary embodiment of the present invention.

Referring to FIG. 3, the mobile device 100 of this invention may provide a function to indicate a proposed separation distance between the mobile device 100 and the target object 1. Specifically, when the target object 1 is placed on the base board 210, a user can adjust horizontally and vertically a relative position of the camera 180 of the mobile device 100 by using the vertical movable joint 230, the horizontal movable joint 250 and the second horizontal arm 260. Here, a separation distance between the camera 180 and the target object 1 may be calculated from the following Equation 1 where a camera angle is represented by ‘θ’, the size (i.e., length) of the target object 1 is represented by ‘a’, and the separation distance is represented by ‘T’.

$$T = \frac{a}{2 \times tan ( \frac{θ}{2} )} \qquad [ Equation 1 ]$$

Here, the camera angle θ is predetermined when the mobile device 100 is fabricated. For example, if the camera angle θ is 68 degrees and the target object 1 has the A4 paper size, the separation distance T is computed to be about 22 centimeters from the Equation 1. The mobile device 100 calculates the separation distance T in such a way and then may output calculation results on the display unit.

Additionally, the mobile device 100 may estimate the size of the target object 1 by detecting the ratio of length to breadth of the target object 1 through an analysis of a target object image obtained by the camera 180. That is, considering the ratio of length to breadth of the target object 1, the mobile device 100 may determine which given paper size corresponds to the target object 1 and then determine the target object size ‘a’. For example, if the target object 1 has a ratio corresponding to 210 mm×297 mm in breadth and length, the mobile device 100 determines that the target object 1 has the A4 paper size. Therefore, the mobile device 100 can determine the target object size ‘a’ from a predefined A4 paper size. Here, the mobile device 100 may display a pop-up window which notifies a user to confirm the target object size ‘a’. A user can select the target object size in the pop-up window or directly input other size through the input unit.

When the size of the target object 1 is determined, the mobile device 100 calculates the separation distance T from the above Equation 1. Then, the calculated separation distance is provided as a proposed separation distance through the display unit for example. A user can therefore adjust an actual distance between the mobile device 100 and the target object 1 by moving the vertical movable joint 230 along the post 220 until the actual distance reaches the proposed distance.

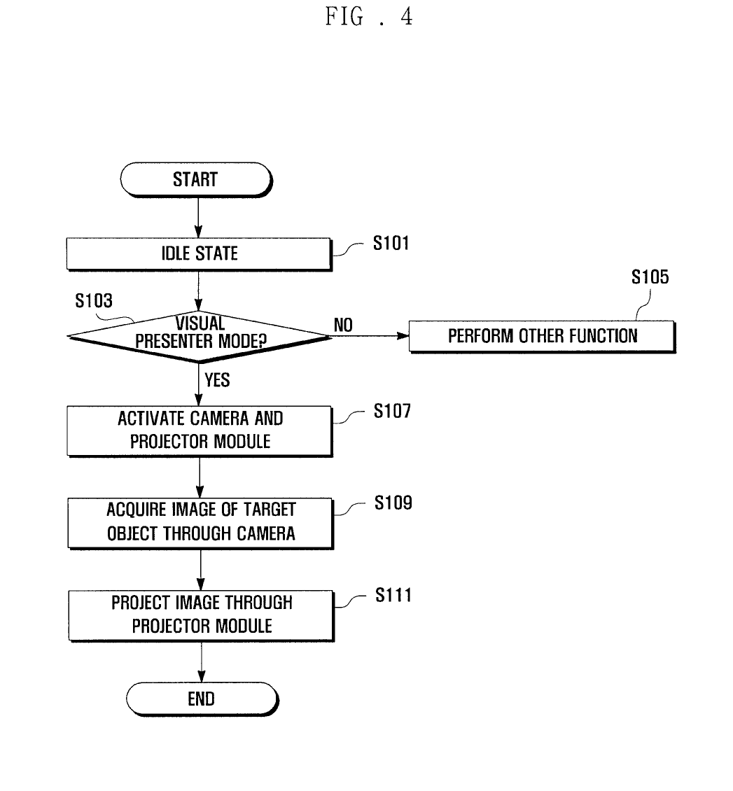

FIG. 4 is a flow diagram which illustrates a method for executing a visual presenter function in accordance with an exemplary embodiment of the present invention.

Referring to FIG. 4, at the outset, the mobile device completes the booting by initializing each element thereof. After the booting, the mobile device outputs a predefined idle page on the display unit (step S101).

Next, the mobile device determines whether a visual presenter mode is selected (step S103). That is, the mobile device ascertains whether a specific menu item or a predefined hot key for starting a visual presenter mode is selected. If there is no selection for the start of a visual presenter mode in the step S103, the mobile device may perform other available functions such as a file search function, a call function, a camera function, a projector function, a game function, etc. according to a user's selection (step S105).

If receiving an input signal for starting a visual presenter mode in the step S103, the mobile device activates simultaneously or sequentially the camera and the projector module (step S107). Here, the mobile device may activate the lighting unit disposed near the camera so that the lighting unit may emit a bright light. Additionally, if an illumination sensor is equipped, the mobile device may automatically control the lighting unit according to an outside illumination value.

Next, the mobile device acquires an image of the target object through the activated camera (step S109). Here, the mobile device may offer a focus adjusting function for the camera when there is an input of a half-shutter key, and then may control the adjusted focus to be maintained until there is other subsequent input. Therefore, the mobile device may obtain real-time preview images continuously. If there is an input signal for taking a video, the mobile device may acquire a moving image of the target object through the camera. Also, if an auto focusing function is set to the camera, the mobile device may control the camera to perform an auto focusing function against the target object placed on the base board in a visual presenter mode.

Next, the mobile device performs an image processing for the acquired preview image or moving image in order to convert it into a new form adapted to the projector module. Then the mobile device controls the projector module to project the converted image onto the external display screen (step S111). Here, the mobile device may adjust the display direction and ratio of the acquired preview image or moving image in order to suitably project it onto the external display screen. For example, in a case where the acquired preview image or moving image has a display ratio of 4:3, the mobile device may offer a changed image with a display ratio of 16:9 to the projector module.

When an image acquired by the camera is forwarded to the projector module, the mobile device may control the display unit to output or not to output such an image according to a user's setting environment. In a case where an image is not outputted on the display unit, the mobile device may output instead a menu page required for further optional functions in a visual presenter mode. Alternatively, such a menu page may be overlaid on an image displayed on the display unit. In other embodiment, the mobile device may output such a menu page on the display unit only without sending it to the projector module.

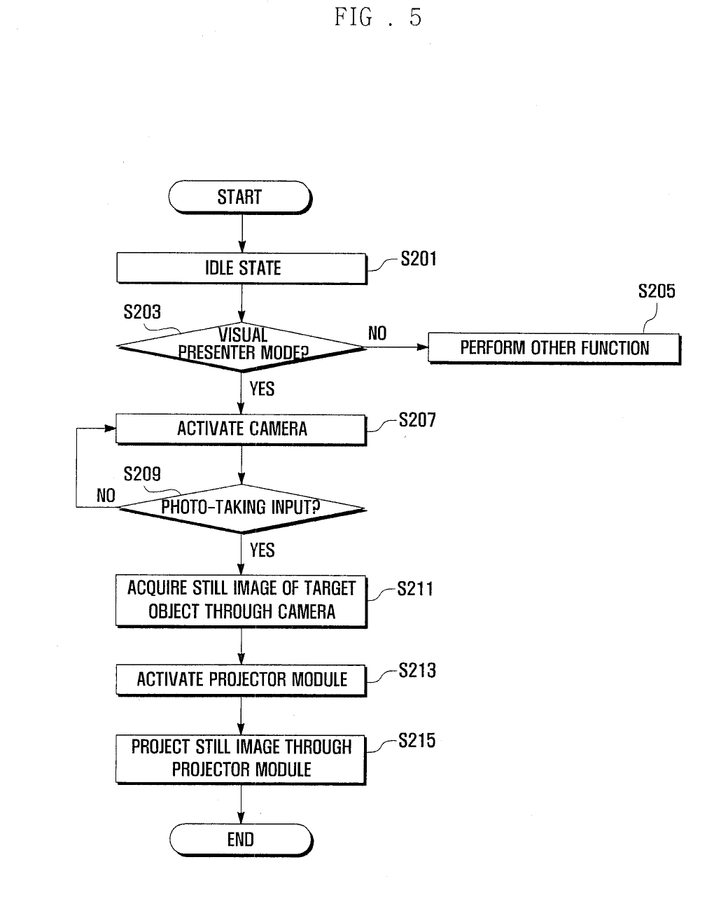

FIG. 5 is a flow diagram which illustrates a method for executing a visual presenter function in accordance with another exemplary embodiment of the present invention.

Referring to FIG. 5, after the mobile device completes the booting by initializing each element thereof, the mobile device outputs a predefined idle page on the display unit (step S201).

Next, the mobile device determines whether a visual presenter mode is selected (step S203). That is, the mobile device ascertains whether a specific menu item or a predefined hot key for starting a visual presenter mode is selected. If there is no selection for the start of a visual presenter mode in the step S203, the mobile device may perform other available functions such as a file search function, a call function, a camera function, a projector function, a game function, etc. according to a user's selection (step S205).

If receiving an input signal for starting a visual presenter mode in the step S203, the mobile device activates the camera (step S207). Here, the mobile device may activate the lighting unit disposed near the camera so that the lighting unit may emit a bright light. Additionally, if an illumination sensor is equipped, the mobile device may automatically control the lighting unit according to an outside illumination value.

Next, the mobile device determines whether there is an input signal for taking a photograph (step S209). Such an input signal for taking a photograph may be created when a user selects a corresponding menu item, presses a corresponding special key, or touches a corresponding virtual key on the display unit. If there is no input signal for taking a photograph, the mobile device maintains the activated state of the camera in the previous step S207.

If there is an input signal for taking a photograph in the step S209, the mobile device acquires a still image of the target object and stores the acquired still image temporarily or semi-permanently according to a user's setting or input (step S211). Here, the mobile device may offer a focus adjusting function for the camera when there is an input of a half-shutter key, and then may take a photograph to obtain a still image when there is an input of a shutter key. Also, the mobile device may convert a still image into a new form adapted to the projector module when storing such a still image. That is, the mobile device may convert a still image into an image with direction and ratio proper to be projected onto the external display screen through the projector module.

Thereafter, the mobile device activates the projector module (step S213), and controls the projector module to project the stored still image onto the external display screen (step S215). If a still image is not converted in the aforesaid step S211, the mobile device may perform the above-discussed conversion of a still image in this step S215.

As fully discussed heretofore, the method for executing a visual presenter function according to an embodiment of the present invention may include activating simultaneously or sequentially the camera and the projector module when a visual presenter mode is selected. This method may further include keeping a focus function of the camera to offer a reliable resolution for the target object, performing an image processing of a preview image, a still image and a moving image to be adapted to the projector module, and controlling the projector module to project such images onto the external display screen. Therefore, the inventive method may make it possible to execute a visual presenter function through the mobile device only, and also, may enhance the portability and utility.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for executing a visual presenter function in a mobile device, the method comprising:
selecting a visual presenter mode in a menu of the mobile device;
activating a camera of the mobile device when the visual presenter mode is selected;
acquiring an image of a target object through the camera;
activating a projector module of the mobile device; projecting the acquired image through the activated projector module;
estimating the size of the target object;
calculating a proposed separation distance between the camera and the target object based on a camera angle and the estimated size of the target object; and
providing the proposed separation distance prior to acquiring the image.

2. The method of claim 1, further comprising at least one of:
after adjusting a focus for the target object according to an input, maintaining the adjusted focus until other input occurs; and
performing an auto focusing for the target object when the camera is activated.

3. The method of claim 1, wherein the acquiring of the image of the target object includes at least one of:
acquiring a preview image of the target object;
acquiring and storing a moving image of the target object; and
acquiring and storing a still image of the target object.

4. The method of claim 3, wherein the acquiring and storing of the still image of the target object includes:
receiving an input signal for acquiring the still image;
performing a focus adjustment for the target object;
acquiring the still image with adjusted focus; and
storing the acquired still image.

5. The method of claim 3, further comprising:
inactivating the camera after the acquiring of the still image; and
activating the inactivated camera when receiving an input signal for acquiring the still image.

6. The method of claim 3, further comprising:
inactivating the camera after the acquiring of the moving image; and
activating the inactivated camera when receiving an input signal for acquiring the moving image from an input unit.

7. The method of claim 1, wherein the projecting of the acquired image includes:
converting the acquired image into an image adapted to a predetermined display ratio and a specific direction; and
projecting the converted image the projector module onto an external display screen.

8. The method of claim 1, wherein the estimating of the size of the target object includes at least one of:
obtaining the size of the target object from an input through an input unit; and
determining the size of the target object from the ratio of length to breadth of the acquired image of the target object.

9. The method of claim 1, further comprising:
outputting the acquired image on a display unit of the mobile device.

10. The method of claim 1, further comprising:
outputting a menu page required for other optional functions in the visual presenter mode on a display unit of the mobile device.

11. A mobile device for executing a visual presenter function, the mobile device comprising:
a camera configured to be activated when a visual presenter mode is selected and to acquire an image of a target object;
a projector module configured to project the acquired image; and
a control unit configured to control the projector module to project the acquired image;
wherein the control unit is further configured to estimate the size of the target object by obtaining the size of the target object from an input through an input unit or by determining the size of the target object from the ratio of length to breadth of the acquired image of the target object, to calculate a proposed separation distance between the camera and the target object by using a camera angle and the estimated size of the target object, and to provide the proposed separation distance.

12. The mobile device of claim 11, further comprising at least one of:
a lighting unit configured to be disposed near the camera;
a display unit configured to output at least one of the acquired image and a menu page required for other optional functions in the visual presenter mode; and
an input unit configured to create an input signal for selecting the visual presenter mode.

13. The mobile device of claim 11, wherein the control unit is further configured to convert the acquired image into an image adapted to a predetermined display ratio and a specific direction, the acquired image being at least one of a preview image, a moving image and a still image.

14. The mobile device of claim 11, wherein the control unit is further configured to adjust a focus for the target object automatically or according to an input from an input unit when the camera is activated, and to maintain the adjusted focus until other input occurs.

15. The mobile device of claim 11, wherein the control unit is further configured to inactivate the camera after acquiring at least one of a still image and a moving image, and to activate the inactivated camera when receiving an input signal for acquiring at least one of the still image and the moving image from an input unit.

16. A holder for a mobile device comprising:
a device fixing part which securely fixes the mobile device which includes a camera configured to be activated when a visual presenter mode is selected and to acquire an image of a target object, a projector module configured to project the acquired image, and a control unit configured to control the projector module to project the acquired image;
a horizontal member which movably supports the device fixing part and allows a horizontal movement of the device fixing part; and
a vertical member which movably supports the horizontal member and allows a vertical movement of the horizontal member.

17. The holder of claim 16, wherein the horizontal member includes:
a first horizontal arm movably coupled to the vertical member;
a horizontal movable joint movably coupled to the first horizontal arm;
a second horizontal arm movably coupled to the horizontal movable joint in order to allow the device fixing part to move horizontally; and
a rotational joint interposed between the second horizontal arm and the device fixing part in order to allow the device fixing part to rotate freely in a stationary position.

18. The holder of claim 16, further comprising:
a base board on which the target object is placed,
wherein the vertical member includes:
a post extended upwardly from one portion of the base board; and
a vertical movable joint movably fixed to the post, securely supporting the first horizontal arm, and allowing a vertical movement of the first horizontal arm.
